(19) United States
(12) Patent Application Publication
(10) Pub. No.: US 2002/0083188 A1
(43) Pub. Date: Jun. 27, 2002

(54) Method for determining web page loading and viewing times

(75) Inventors: Xavier Le Hericy, Portland, OR (US); Victor Lu, Portland, OR (US); Wade Smith, Tualatin, OR (US)

Correspondence Address: MARGER JOHNSON & McCOLLOM, P.C., 1030 S.W. Morrison Street, Portland, OR, 97205, US

(73) Assignee: WebTrends Corporation, Portland, OR

(21) Appl. No.: 10/016,522

(22) Filed: Nov. 1, 2001

Related U.S. Application Data
(60) Provisional application No. 60/245,647, filed on Nov. 2, 2000.

(51) Int. Cl. G06F 15/16

(52) U.S. Cl. 709/235

(57) ABSTRACT

A method for tracking and reporting visitor-side web page loading times over a web site where a web page is stored on a first server coupled to a wide area network. The web page is provided with web page code and data mining code which is uploaded through the wide area network to a visitor computer responsive to a request over the wide area network from the visitor computer. The data mining code is operated on the visitor computer to obtain a begin state at a start of the web page load. A state change is then on the visitor computer to an end state caused by a completed upload of the web page to the visitor computer. The process then proceeds with comparing the begin state and the end state to obtain page loading time data and receiving the page loading time data at a second server.

### CROSS-REFERENCE TO RELATED APPLICATIONS

This application claims the benefit from U.S. Provisional Patent Application No. 60/245,647 filed Nov. 2, 2000 whose contents are incorporated herein for all purposes.

### BACKGROUND OF THE INVENTION

1. Field of the Invention

The present application relates to compiling and reporting data associated with activity on a network server and more particularly to compiling and reporting server data that is associated with web page load times.

2. Description of the Prior Art

Programs for analyzing traffic on a network server, such as a worldwide web server, are known in the art. One such prior art program is described in U.S. patent application Ser. No. 09/240,208, filed Jan. 29, 1999, for a Method and Apparatus for Evaluating Visitors to a Web Server, which is incorporated herein by reference for all purposes. Web Trends Corporation owns this application and also owns the present provisional application. In these prior art systems, the program typically runs on the web server that is being monitored. Data is compiled, and reports are generated on demand—or are delivered from time to time via email—to display information about web server activity, such as the most popular page by number of visits, peak hours of website activity, most popular entry page, etc.

Analyzing activity on a worldwide web server from a different location on a global computer network (“Internet”) is also known in the art. To do so, a provider of remote web-site activity analysis (“service provider”) generates JavaScript code that is distributed to each subscriber to the service. The subscriber copies the code into each web-site page that is to be monitored.

When a visitor to the subscriber's web site loads one of the web-site pages into his or her computer, the JavaScript code collects information, including time of day, visitor domain, page visited, etc. The code then calls a server operated by the service provider—also located on the Internet—and transmits the collected information thereto as a URL parameter value. Information is also transmitted in a known manner via a cookie.

Each subscriber has a password to access a page on the service provider's server. This page includes a set of tables that summarize, in real time, activity on the customer's web site.

The above-described arrangement for monitoring web server activity by a service provider over the Internet is generally known in the art. Information analyzed in prior art systems generally consists of what might be thought of as technical data, such as most popular pages, referring URLs, total number of visitors, returning visitors, etc. One piece of information that is useful to but is not provided to a site owner is how long a page takes to load on a visitor's computer. If page loads are taking too long, then a web site operator can redesign the page to load faster and/or add new web page server equipment to make the site more responsive to user requests.

Accordingly, the need still remains for a way to track and report client-side performance characteristics, namely how quickly a subscriber's web page loads on a visitor's computer, since low client-side performance measurements could mean that the web site is not designed properly for its target audience.

### SUMMARY OF THE INVENTION

A method and apparatus is disclosed for tracking and reporting visitor-side web page loading and viewing times of a web site that is stored on a first server coupled to a wide area network.

The web page includes data mining code embedded within the web page display code. The data mining code, operating within the browser program of the visitor computer, gathers various operating criteria from the visitor computer. Software code within the data mining code traps the time the page begins to load using a function such as startTime, which is contained within a script (e.g. JavaScript) block operating during the initial loading of the web page within the web page browser software.

A second script block creates an image with no source specified and creates two new functions that will be executed by functions that are adapted to fire when the web page is fully loaded (e.g. the onLoad event handler) and again when the browser is instructed by the computer operator to move to a different web page (e.g. the onUnload event handler). The functionality of the existing Load and Unload events is written into two function pointers. The onLoad and onUnload event handlers are then overloaded and renamed with functions having enhanced features, wtLoad and wtUnLoad. WtLoad and wtUnLoad execute the original code stored in the appropriate function pointer as well as executing additional code for statistics logging purposes. When the onLoad event handler is fired, wtLoad builds a string of all the gathered information that is to be sent to the server doing the logging. By setting the source of the image to a variable built by the script, all the gathered information including the page load time can be passed to the web server doing the logging.

There are many techniques that could be used within this general context for getting the load time. For example the top script could also set a timer or an interval to track the page load time.

An alternate method uses the onReadyStateChange function. Microsoft Corporation's Internet Explorer (IE) browser program is the only browser that supports the onReadyStateChange event handler. The start time is captured at the top and the onReadyStateChange event handler is overloaded to call wtTime. Once the page has completed loading, the wtTime function is called and sets the image source as described above. A function pointer could also be implemented to preserve any functionality specified for onReadyStateChange in the body tag.

A final technique has proven to be less reliable and yields slightly different results depending upon which browser program is operating on the visitor computer. According to this final technique, the time at the top and bottom of the page is captured and then written as an image to send data to the server.

The foregoing and other objects, features and advantages of the invention will become more readily apparent from the following detailed description of a preferred embodiment of the invention that proceeds with reference to the accompanying drawings.

### BRIEF DESCRIPTION OF THE DRAWINGS

FIG. 1 is a schematic view of a portion of the Internet on which the invention is operated.

FIG. 2 is a flow diagram illustrating a method for reporting visitor-side web page load time according to a preferred embodiment of the invention.

FIGS. 3A and 3B are flow diagrams illustrating the method for reporting visitor-side web page load time according to an alternate embodiment of the invention.

FIG. 4 is exemplary computer code implementing a first embodiment of the invention.

FIG. 5 is exemplary computer code implementing a second embodiment of the invention.

FIG. 6 is exemplary computer code implementing a third embodiment of the invention.

### DETAILED DESCRIPTION

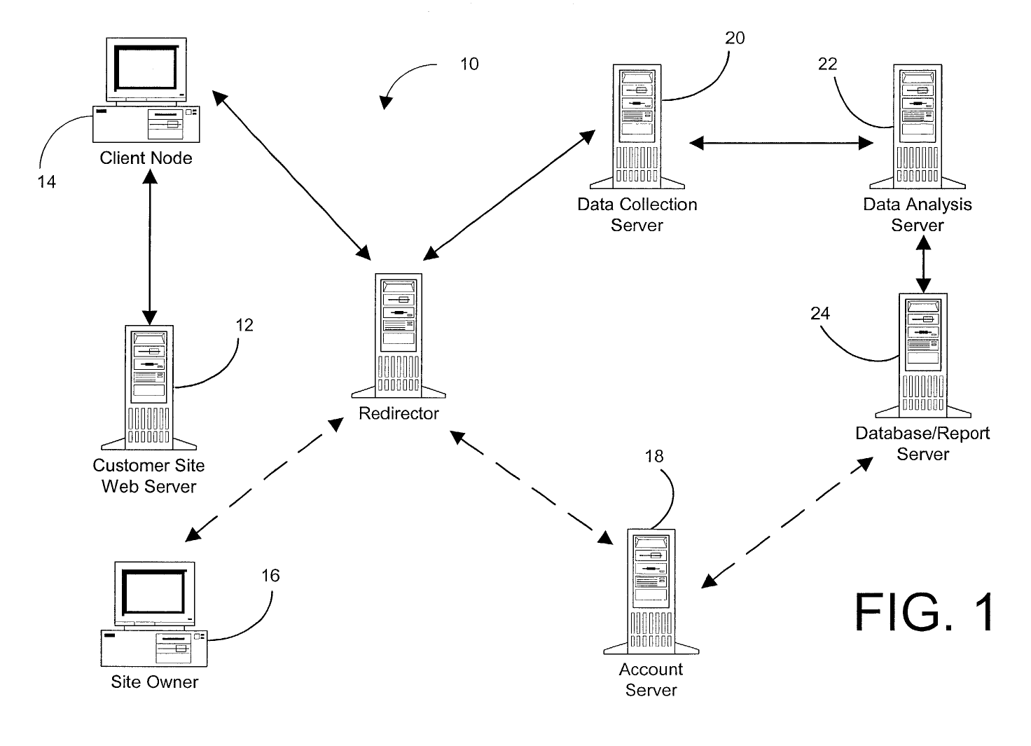

Turning now to FIG. 1, indicated generally at 10 is a highly schematic view of a portion of the Internet implementing the present invention. Included thereon is a worldwide web server 12. Server 12, in the present example, is operated by a business that sells products via server 12, although the same implementation can be made for sales of services via the server. The server includes a plurality of pages that a site visitor can download to his or her computer, like computer 14, using a conventional browser program running on the computer. Examples of the type of pages that a visitor can download include informational pages and pages that describe the business and the products or services that are offered for sale.

As mentioned above, it would be advantageous to the seller to have an understanding about how customers and potential customers use server 12. As also mentioned above, it is known to obtain this understanding by analyzing web-server log files at the server that supports the selling web site. It is also known in the art to collect data over the Internet and generate activity reports at a remote server.

When the owner of server 12 first decides to utilize a remote service provider to generate such reports, he or she uses a computer 16, which is equipped with a web browser, to visit a web server 18 operated by the service provider. On server 18, the subscriber opens an account and creates a format for real-time reporting of activity on server 12.

To generate such reporting, server 18 provides computer 16 with a small piece of code, typically JavaScript code. The subscriber simply copies and pastes this code onto each web page maintained on server 12 for which monitoring is desired. When a visitor from computer 14 (client node) loads one of the web pages having the embedded code therein, the code passes predetermined information from computer 14 to a server 20—also operated by the service provider—via the Internet. This information includes, e.g., the page viewed, the time of the view, the type of browser used, the visitor's identification, etc. Server 20 in turn transmits this information to an analysis server 22, which is also maintained by the service provider. This server analyzes the raw data collected on server 20 and passes it to a database server 24 that the service provider also operates.

When the subscriber would like to see and print real-time statistics, the subscriber uses computer 16 to access server 18, which in turn is connected to database server 24 at the service provider's location. The owner can then see and print reports, like those available through the webtrendslive.com reporting service operated by the assignee of this application, that provide real-time information about the activity at server 12.

Applicants have developed techniques for gathering information on page load times, examples of which are disclosed below:

1. Overloading window.onload and window.onunload Event Handlers;

2. OnReadyStateChange Trigger; and

3. Top-Bottom Split JavaScript Tags.

Each of these three techniques is implemented using JavaScript commands embedded within the JavaScript of the page to be loaded on a visitor's computer.

Modem web browsers such as Internet Explorer (IE) and Netscape Navigator operate to send for, retrieve and load web pages. A common method for implementing web pages is to use html or JavaScript code, which is interpreted by the web browser and implemented on the computer requesting the web page and including the web browser program. A common feature of modem web browsers is the use of events to trigger or “fire” operations called an “Event Handler”. For example, moving a mouse cursor over a predefined hotspot or button on a web page can trigger a “mouseover” event. The triggering of such an event can be used by such browser plug in technologies as Flash (created by Macromedia, Inc.) to run a subroutine that changes the hotspot from one graphic to another'when the mouse pointer moves within a preset boundary of the web page. Other events that are important for the purposes of this invention are the page onloading event that triggers when the web page has completed its loading on the visitor's computer.

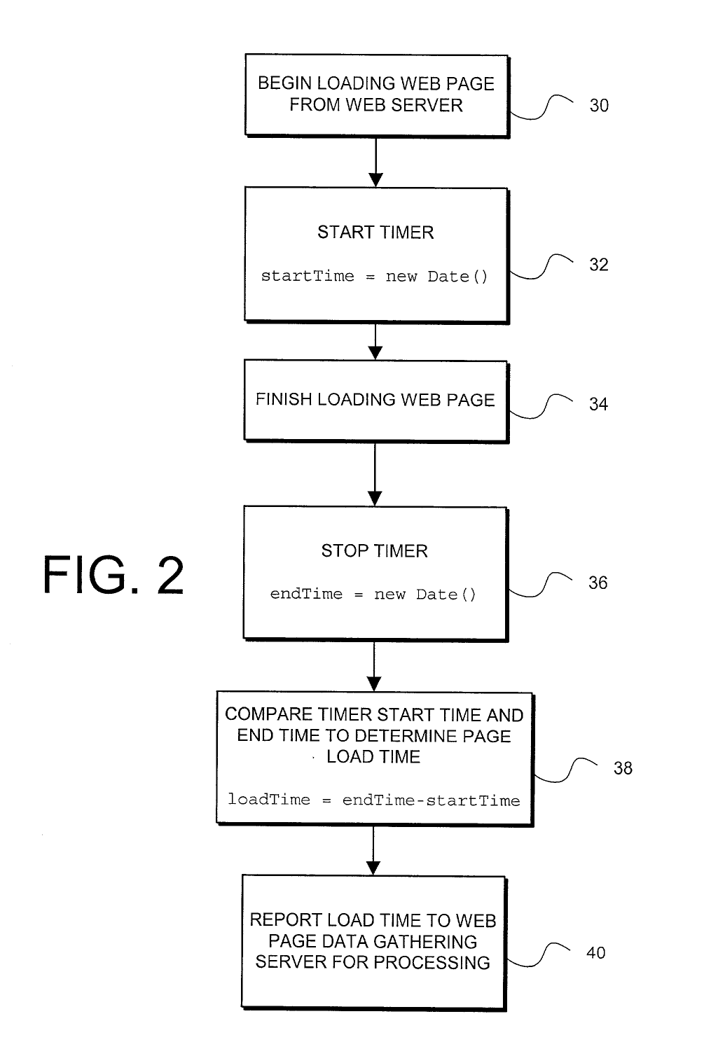

Although determining page load times is an important use for the present invention, it is understood that the invention need not be limited to such a determination. The concept embodied within the invention involves determining STATE CHANGES in the web page. In the case of page loading time, the particular state measured is whether the page is completely loaded. Accordingly, the time in which it takes a client node to change from a first state (page not loaded) to a second state (page loaded), as measured from the point at which a user first begins loading the web page, can be shown by the flow chart of FIG. 2. That is, the client node begins loading a web page from web server 12 (step 30) and a timer is started (step 32). When the web page is finished loading (step 34), the timer is stopped (step 36). In a computer setting, it is most convenient to base the time on the computer clock running on the client node. Accordingly, the load time for the web page can be determined by comparing the time at which the page started to download from the time the download was completed (step 38). The load time is then reported to a web page data server for collection (step 40), processing and reporting as with other web traffic statistics.

The broad concept of acting upon state changes can thus be expressed as capturing a state at the beginning of the page load, capturing a state at the end of the page load, and reporting the state differences between the state at the beginning and end of the page load where the state can report on the (a) the time to load the page, (b) whether the page load was abandoned before loading was completed, or (c) whether one or more of the web page images are successfully downloaded to the visitor computer. Examples of three different techniques for implementing this invention to capture page load times are described below:

#1: Setting a Timer to Track the Page Load Time

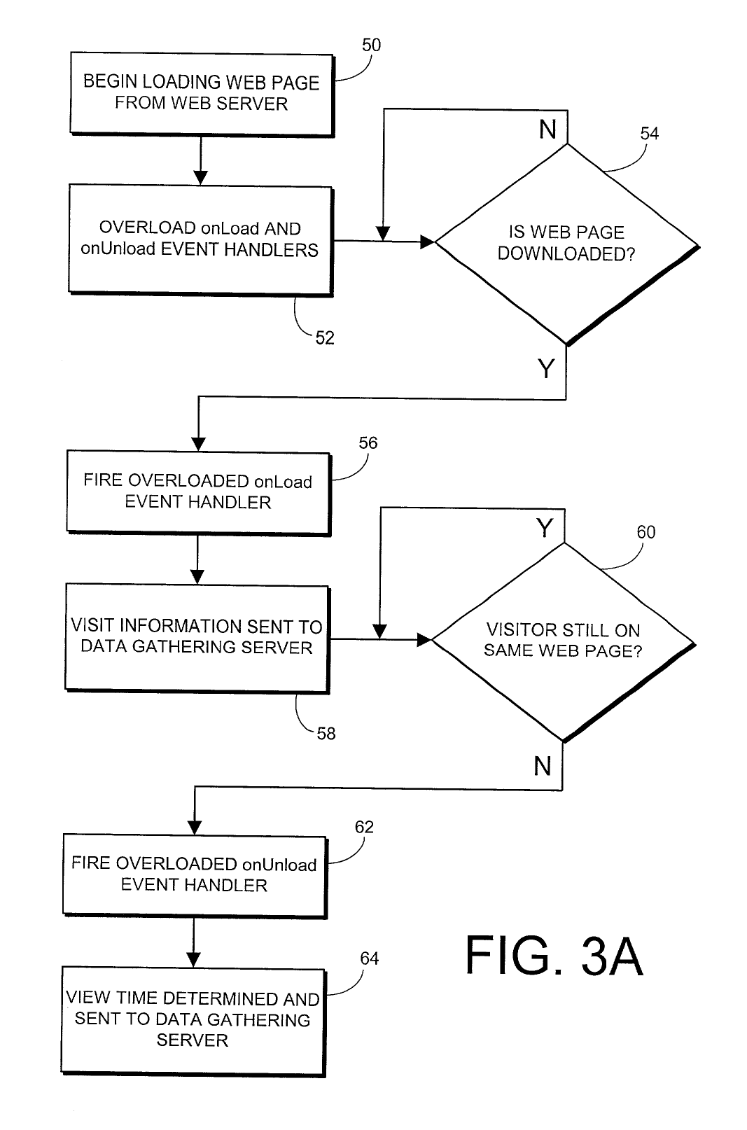

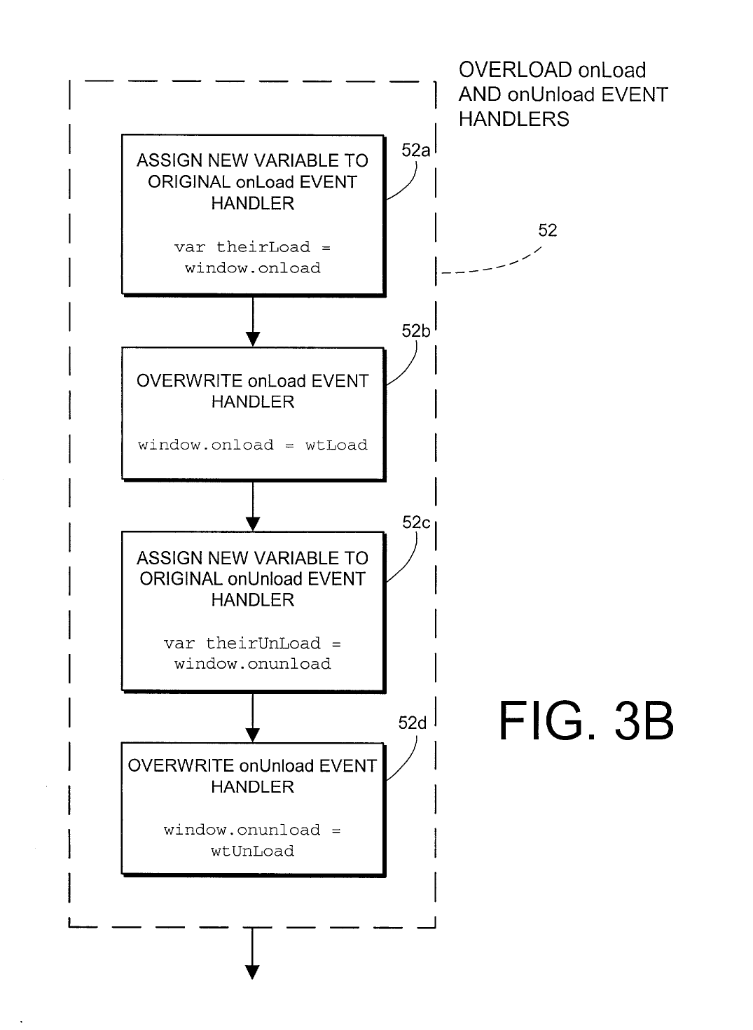

The flow charts shown in FIGS. 3A and 3B illustrate the process steps performed using technique #1 to overload the onLoad and onUnload event handlers so that page load and page view time can be calculated and uploaded to the data gathering server responsible for logging web site visitor data, where the step of overloading the onLoad and onUnload event handlers in FIG. 3A is implemented as shown in FIG. 3B.

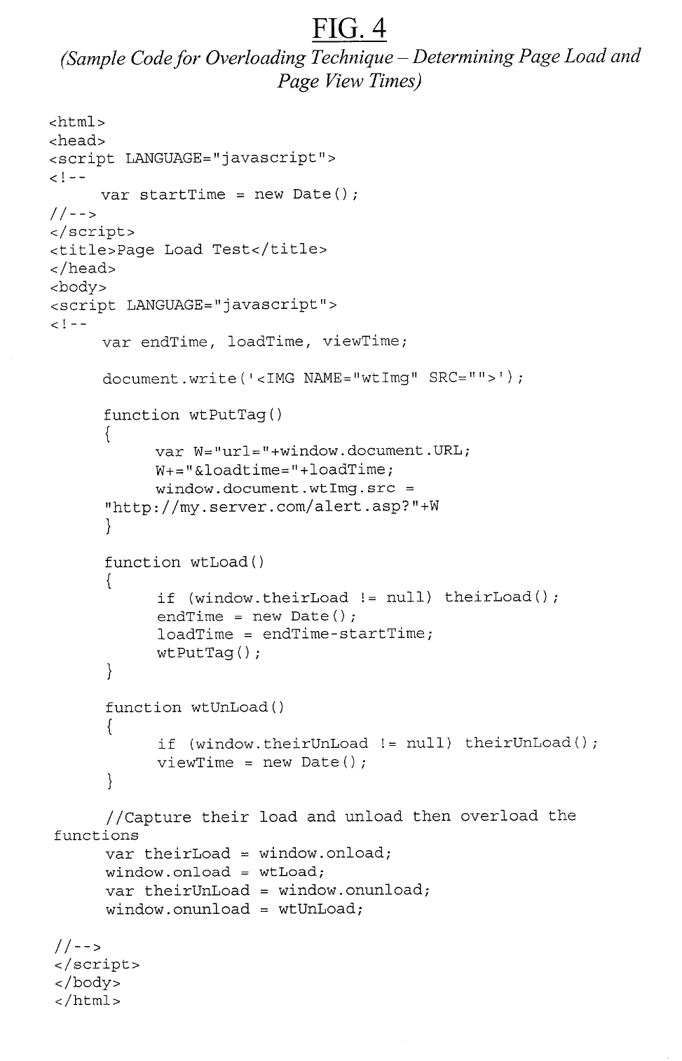

The web page from customer web site server 12 is downloaded by client node 14 responsive to a request to server 12 over the Internet. As the page begins to load onto client node 14 in block 50 in FIG. 3A, the code shown in FIG. 4 records the time from the client node computer clock using a function such as startTime. The startTime function is placed at the beginning of the JavaScript code within the downloaded web page to operate at the beginning of the downloading process.

A second script within the JavaScript code creates an image with no source specified the source is later completed by operation of the data mining code as described below. It then creates two new functions that will be executed by the onLoad and onUnload event handlers. The onLoad event fires when all page script and images are downloaded. The onUnload event fires when the visitor moves to a different web page or closes down the browser. The functionality of the existing onLoad and onUnload events is written into two function pointers (shown in FIG. 4 as theirLoad and theirUnload).

The onLoad and onUnload event handlers are then associated with new superseding code (called “overloading”) in block 52 so they will call new functions wtLoad and wtUnLoad. WtLoad and wtUnload execute the original code stored in the appropriate function pointer as well as executing additional code for statistics logging purposes. The status of the web page on the client node—that is, whether it has been successfully downloaded—is tracked in query block 54. The overloaded onLoad event handler fires when the web page is completely downloaded in block 56 to obtain a second computer clock reading. When the onLoad event handler is fired, wtLoad builds a string of all the gathered information that is to be sent to the server doing the logging in block 58.

At some point, the visitor to the web site will either click on a hyperlink within the site to move to a different web page, enter a different web address in the destination field of the browser window, or exit the browser program. Each of these activities will cause the visitor to disconnect from the web page he or she was previously viewing. The status of the web page on the client node—that is, whether the visitor is still on the web page—is tracked in query block 60. The overloaded onUnload event handler fires when the browser moves from the existing web page in block 62 to obtain a third computer clock reading. When the onUnload event handler is fired, wtUnload builds a string of all the gathered information that is to be sent to the server doing the logging in block 64. The gathered information is appended to the earlier created sourceless image as described below, where block 58 and block 64 steps can be incorporated simultaneously to send a single code string to data collection server 20.

By setting the source of the image to a variable built by the script (e.g. www.webtrendslive.com/button3.asp?id39786c45629t120045), all the gathered information can be passed to the web server doing the logging, e.g. data collection server 20 (FIG. 1). In this case, for instance, the variable script “id39786c45629t120045” is sent to a location such as incorporated within applicants' webtrendslive.com web site and is interpreted by a decoder program built into the data analysis server 22 to mean that a user with ID#39786, loaded client web site #45629 in 4.5 seconds and spent 1:20 minutes there before moving to another web site.

That is, when the onLoad event handler is fired due to the “page finished loading” event, a process code string (wtLoad) is run which includes the original onLoad event handler (renamed in the present embodiment as theirLoad) and supplemental code string as included below:

function wtLoad()
{

if (window.theirLoad != null) theirLoad();
endTime = new Date();
loadTime = endTime-startTime;
wtPutTag();

}

, where the wtPutTag function is written as:

function wtPutTag ()
{

var W=“url=”+window.document URL;
W+=“&loadtime=”+loadTime;
window.document.wtImg.src =

“http://my.server.com/alert.asp?”+W
}

FIG. 3B illustrates in more detail the overloading technique practiced according to a preferred implementation of the invention. The original onLoad event handler is equated with a new variable “theirLoad” in block 52a. The original onLoad event handler is then overwritten with a new functionality in wtLoad in block 52b. Similarly, the original onUnload event handler is equated with a new variable “theirUnload” in block 52c and then overwritten with a new functionality in wtUnload in block 52d.

#2: Using the onReadyStateChange event handler of Internet Explorer

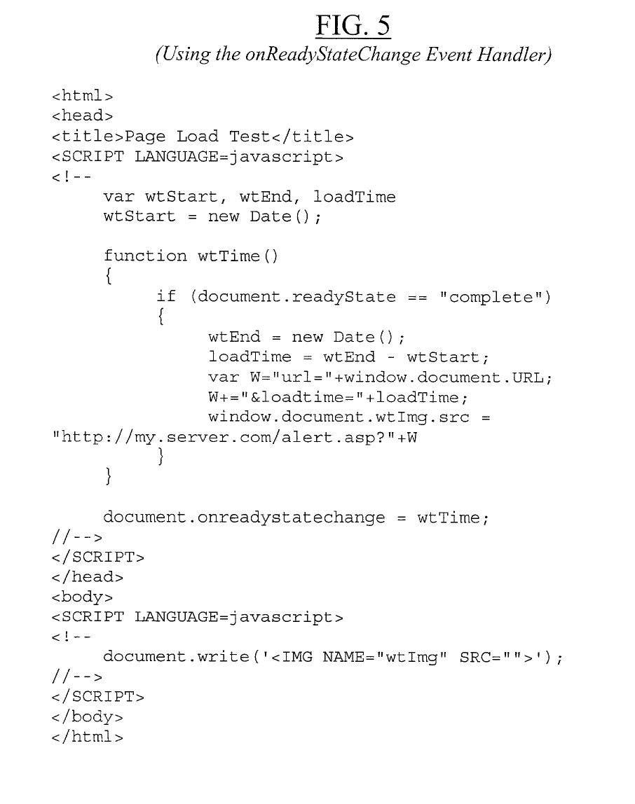

This technique is similar to technique #1 above, but Microsoft's Internet Explorer is the only browser that supports the onReadyStateChange event handler. The start time is captured at the top [wtStart=new Date( )] and the onReadyStateChange event handler is overloaded to call wtTime. Once the page has completed loading, the wtTime function is called and sets the image source as described above. A function pointer could also be implemented to preserve any functionality specified for onReadyStateChange in the body tag. Sample code used to implement this technique is included in FIG. 5.

(1) Thus, in a first step, the time is grabed from the clock running on the visitor's computer:

wtStart=new Date( );

(2) Next, the onReadyStateChange event handler is overwritten with a new instruction called wtTime:

document.onreadystatechange=wtTime;

where the wtTime event handler is programmed as:

function wtTime()
{

if (document.readyState == “complete”)

{

wtEnd = new Date();
loadTime = wtEnd − wtStart;
var W=“url=”+window.document.URL;
W+=“&loadtime=”+loadTime;

window.document.wtImg.src =

(3) Third, completion of the page load triggers the wtTime event handler (which overwrote the original onreadystatechange event handler) and sets the image source with page load time data as described above with respect to technique #1.

#3: Using Split JavaScript at the Top and Bottom of the Code String

This third technique simply places a time capture code [wtStart=new Date( ) )] at the beginning of the web page JavaScript code and a second time capture code [wtEnd=new Date( )] at the end of the web page JavaScript code. Time is captured from the computer clock of the visitor's computer downloading the web page. The time for the page to load completely is calculated by the code string [loadTime=wtEnd—wtStart] calculating the differential and an image is written with the data and sent to the data gathering server.

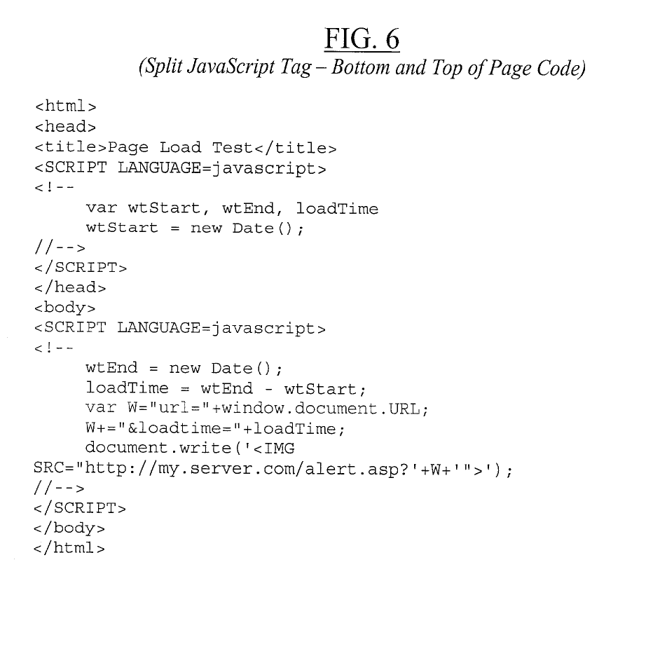

It has been found that, due to certain differences in the way certain web page browsers operate, this technique behaves differently if the browser is Netscape Navagator as opposed to Internet Explorer and thus is sometimes unreliable at accurately capturing the page load time. Sample code implementing this technique can be found in FIG. 6.

Having described and illustrated the principles of the invention in a preferred embodiment thereof, it should be apparent that the invention can be modified in arrangement and detail without departing from such principles. We claim all modifications and variation coming within the spirit and scope of the following claims.

We claim:

1. A method for tracking and reporting visitor-side web page loading times over a web site comprising:
storing a web page on a first server coupled to a wide area network, said web page including web page code and data mining code;
uploading the web page to a visitor computer responsive to a request over the wide area network from the visitor computer;
operating the data mining code on the visitor computer to obtain a begin state at a start of the web page load;
detecting a state change on the visitor computer to an end state caused by a completed upload of the web page to the visitor computer;
comparing the begin state and the end state to obtain page loading time data; and
receiving the page loading time data at a second server.

2. The method of tracking and reporting visitor-side web page loading times of claim 1, further including the steps of:
retrieving a first computer clock reading from the visitor computer at the start of the web page load; and
retrieving a second computer clock reading from the visitor computer upon detection of the visitor computer state change,
wherein the step of comparing the begin state with the end state includes setting the page loading time data as the difference between the second computer clock reading and the first computer clock reading.

3. The method of tracking and reporting visitor-side web page loading times of claim 2, further including the steps of:
detecting a request on the visitor computer to move to a different web page;
operating an event handler embedded within the data mining code to retrieve a third computer clock reading from the visitor computer upon detection of the request;
setting a page viewing time data according to the difference between the third computer clock reading and the second computer clock reading; and
receiving the page viewing time data at the second server.

4. The method of claim 2, further including the step of inserting data mining code capable of retrieving the first computer clock reading at the beginning of the web page code and inserting data mining code capable of retrieving the second computer clock reading at the end of the web page code.

5. The method of tracking and reporting visitor-side web page loading times of claim 1, wherein the data mining code includes a onReadyStateChange event handler.

6. The method of claim 5, further including the step of overloading the onReadyStateChange event handler.

7. The method of tracking and reporting visitor-side web page loading times of claim 1, wherein the data mining code includes the onLoad and onUnload event handlers.

8. The method of claim 7, further including the step of overloading the onLoad and onUnload event handlers.

9. The method of claim 1, further comprising the steps of:
compiling the detected state change within a web site traffic report; and
posting the report for viewing over the wide area network.

10. A method for reporting state changes on visitor computer comprising the steps of:
storing a web page on a first server coupled to a wide area network;
uploading the web page to a visitor computer responsive to a request over the wide area network from the visitor computer;
capturing a begin state at the visitor computer at the beginning of the page load;
capturing an end state at the visitor computer at the end of the page load; and
reporting a state difference between the begin state and the end state to a second server coupled over the wide area network.

11. The method of claim 10 wherein the begin state is equivalent to a computer clock reading on the visitor computer at the start of the web page upload step, the end state is equivalent to a computer clock reading on the visitor computer at the end of the web page upload step, and the state difference between the begin state and the end state is the time difference between the computer clock readings to indicate a time to load the web page.

12. The method of claim 10 further including the step of reporting a web page load failure to the second server if there is no state difference between the begin state and the end state.

13. The method of claim 10, further comprising the steps of:
compiling the state difference within a web site traffic report; and
posting the report for viewing over the wide area network.
